(19) United States
(12) Patent Application Publication
(10) Pub. No.: US 2003/0144856 A1
(43) Pub. Date: Jul. 31, 2003

(54) Business method for memorializing vehicle purchase transactions

(76) Inventors: Gerald Lacour, Leander, TX (US); Garrett Lacour, Leander, TX (US); Robert Cobin, Leander, TX (US); Mat Nowicky, Leander, TX (US)

Correspondence Address: DAVID G. HENRY, 900 Washington Avenue, 7th Floor, P.O. Box 1470, Waco, TX, 77603-1470, US

(21) Appl. No.: 10/060,027

(22) Filed: Jan. 28, 2002

(51) Int. Cl. G06F 17/60

(52) U.S. Cl. 705/1

(57) ABSTRACT

The invention is of a novel business method for recording vehicle purchase transactions involving sales staff and customers. The method involves, through use of a software-driven program on a PC, recording audio and video data using a PC-connected digital video camera and PC-connected microphone, generating transaction-specific data to be saved with the audio and video data, storing the transaction-specific data, audio, and video data onto substantially indelible media in a data file identified by a unique data file name or number, and storing a record of the transaction-specific data and the associated unique file name or number into a searchable database for later location of the transaction recording.

### BACKGROUND OF THE INVENTION

1. Field of The Invention

The present invention relates to business methods, and business methods in the vehicle sales area in particular.

2. Background Information

The vehicle sales arena is an area in which allegations of fraud and unfair sales tactics are rampant. The combination of aggressive sales staff and often unsophisticated purchasers is a volatile combination which often leads to claims against dealerships under the states' various consumer protection statutes and regulations.

Specific sources of dealership and customer conflicts include, among other things, such things as the total cost for a vehicle, the added costs for after-market products and warranty protections, the duration and scope of manufacturer's warranties, perceived promises as to performance or features of the purchased vehicle, the affect of credit given for trade-in vehicles on the ultimate purchase price of the subject vehicle, and the requirements for enrolling in, or making claims under add-on warranty programs (window etching, alarm system warranties, etc.).

When disputes arise between dealerships and customers, they often descend to the level of a “swearing match” between the “big bad car dealer” and the “poor victim customer.” Regardless of the actual facts, and what the customer was told (often times, multiple times), the dealership loses in court, or at least undertakes an expensive defense with no possible remedy when the truth prevails. For the above reasons alone, it would be beneficial to provide, not just some manner for recording the interchange between sales staff and vehicle purchase customers, but to provide a recording system which produces substantially indelible records which are easily retrieved when needed.

In addition to providing protection for dealerships in the legal context, such a transaction recording system will enable supervisors to critique and train sales staff with respect to their demeanor and presentation when dealing with customers, as well as assure that all things within the staff member's responsibilities are being fulfilled (the offer of after-market programs and products, for example).

Further still, such a transaction recording system will actually protect customers in many cases. The stress of a major purchase, the frustration of unrealized expectations, and merely the passage of time can all contribute to flawed memory. A customer may well, honestly believe that one thing was promised, or another was never revealed, only to find out, when viewing the recorded transaction, that memory has played a trick. Such a customer will then avoid the costly and embarrassing experience of seeking legal relief against the dealership, only to find out that there was never a case.

In view of the foregoing, it would well-serve the vehicle sales industry and its customers alike to provide a business method and associated apparatuses which would allow the recording, the substantially indelible archiving, and easily operated cataloging of recorded transactions between sales staff and customers.

### SUMMARY OF THE INVENTION

In view of the foregoing, it is an object of the present invention to provide a novel business method which benefits automobile dealers and customers.

It is another object of the present invention to provide a novel business method for conducting vehicle sales transactions that involves producing substantially indelible audio and video recordings of such transactions.

It is another object of the present invention to provide a novel business method for conducting vehicle sales transactions that involves producing cataloged and easily retrieved audio and video recordings of such transactions.

It is another object of the present invention to provide a novel business method for conduction vehicle sales transactions that involves producing digitally recorded and stored audio and video recordings of such transactions for later retrieval in the event of a dispute as to what was and was not said or disclosed in the transaction.

In satisfaction of these and related objects, the present invention provides a novel business method and associated apparatus which digitally records audio and video data from vehicle sales transactions, stored such recordings on CD-R, CD-RW, DVD-R or DVD-RAM media (or its equivalent), and produces catalog data associated with each transaction recording which allows the recording to be readily located and played at a subsequent time.

### DETAILED DESCRIPTION OF THE PREFERRED EMBODIMENT

The components involved in carrying out the subject business method can be categorized into two major classifications: hardware/equipment and proprietary software.

Hardware:

Wired Digital Video Camera or Wireless Digital Video Camera/Digital Video Receiver

Audio microphone

CD-R, CD-RW, DVD-R, or DVD-RAM drive

Customary cables which allow for interface between hardware components, Microsoft Windows compatible personal computer with color monitor, mouse, and keyboard

Software:

Software program for taking cataloging data through keyboard interface, initiating recording, and completing recording and storing data. Such software is available from Innovative Aftermarket Systems, Inc. of Leander, Tex. (assignee of the subject patent application) under the SMART EYE trademark.

The business method involves installation of a digital video camera on a wall or other suitable location in the financial closing office(s) of a vehicle dealership, where the camera can record the images of all people in the office. The camera is connected, either directly or through a wireless connection, to a personal computer via a USB port. An audio microphone is also connected to the personal computer and is located in an area on the closing desk where it can record the voices of all people speaking in the office.

The CD-R, CD-RW, DVD-R, or DVD-RAM drive can either be internally installed or externally connected to the computer via USB.

The PC will have installed the customary hardware drivers for interfacing with the video camera and the aforementioned disk drives.

After the hardware and software installation is complete, use of the recording system is straightforward.

The software has clickable “buttons” which initiate a recording session, first by bringing up an on-screen form for entering such items as the customer's name, address, vehicle purchased, time, date, etc. for cataloging the to-be-generated audio/video record of the transaction.

Once required fields in the on-screen form are complete, a “CONTINUE” (or equivalent) clickable “button” initiates actual recording. The digital images and audio stream, respectively, from the video camera and the computer microphone are recorded and stored into appropriate data files as the transaction goes on. An on-screen “COMPLETE” (or equivalent) clickable “button” terminates recording and stores the final data file with database information onto the designated storage media.

The subject system may be designed for two-stage storage: a first stage which goes onto the computer's regular (albeit high capacity) hard drive, followed by storage onto more indelible optical media such as CD-R, DVD-R, or DVD-RAM disks, with the DVD-R being of the highest capacity and most indelible format known to date. At the time when the data file is stored with the on-screen entered customer data, a unique file number is assigned to it, and the customer data and the file number is saved to a separate database for later identification.

The just-mentioned database is one which will be searchable as to any field in the original on-screen form. In other words, one can search for all transactions on a particular date, by a certain sales staff member, involving a particular customer, or involving a particular vehicle or product. Any retrieved record will reflect the data file name(s) or number(s) in which these respective recorded transactions are stored. Once having the file name(s) or number(s), a user can retrieve the file(s) from the long-term storage disk(s) according to the archiving system of the dealership.

It should be noted that the on-screen data form can easily be customized to gather and catalog any desired information that a dealership would like to track or by which the recorded data may be cataloged.

The subject business method allows for a permanent record of what happened during the actual closing of vehicle purchase transaction, supplementing the actual signed paperwork. This permanent record can be used in the event any discrepancies or disputes arise in the future regarding the transaction. This record benefits and protects all parties to the transaction.

Having a permanent video/audio record of the actual transaction helps ensure any written documents are not misrepresented, misinterpreted, or improperly disclosed to the customer.

Business management can monitor all transactions or spot check transactions to ensure employee compliance with fair business tactics and local, state, or federal laws. Additionally, management can use the record to improve the employee's ability to properly explain the transaction and/or complex documents and agreements related to the transaction.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A business method for memorializing vehicle purchase transactions comprising the steps of:
selecting a video camera;
selecting computer means;
interfacing said video camera with said computer means;
installing computer software onto said computer means, which software effects initiation and termination of recordation of video images into a data file, associates user-inputted unique data specific to said purchase transaction with said data file upon saving of said data file to storage media, assigns a unique identifier to said file as said file is recorded to said storage media at termination of said recordation, and, upon stores a record of said unique data and said unique identifier into a searchable database wherein multiple data files may be searched with respect to said unique data;
actuating said computer software for input of said user inputted unique data;
actuating said computer software for initiation of said recording of said transaction;
at the end of a transaction which is to be recorded, actuating said computer software for termination of said recordation and storage of said data file onto said storage media and of said record into said database.

2. The business method of claim 1 further comprising the steps of:
selecting an audio microphone;
interfacing said audio microphone with said computer;
including in said computer software, features for initiation of audio recording substantially simultaneous with said recordation of video images by said video camara, and storage of audio data into said data file, thereby producing an audio video record of said transaction.
